(19) United States
(12) Patent Application Publication
(10) Pub. No.: US 2023/0336255 A1
(43) Pub. Date: Oct. 19, 2023

(54) DATA COLLECTION METHOD, SENSOR DEVICE, SERVER DEVICE, VISUALIZATION SYSTEM, AND NON-TRANSITORY COMPUTER-READABLE MEDIUM

(71) Applicant: NEC Corporation, Minato-ku, Tokyo (JP)

(72) Inventor: Takamichi INOUE, Tokyo (JP)

(73) Assignee: NEC Corporation, Minato-ku, Tokyo (JP)

(21) Appl. No.: 17/928,088

(22) PCT Filed: May 26, 2021
(86) PCT No.: PCT/JP2021/019956

§ 371 Date: Nov. 28, 2022

(30) Foreign Application Priority Data
May 29, 2020 (JP) 2020-093935

(51) Int. Cl. H04B 17/318; H04W 24/08; H04W 24/10

(52) U.S. Cl. CPC H04B 17/318; H04W 24/08; H04W 24/10

(57) ABSTRACT

An object of the present disclosure is to provide a data collection method being capable of suppressing a data amount of data being transmitted to a server device that performs monitoring. The data collection method according to the present disclosure includes collecting a packet being transmitted in a wireless system, generating a plurality of pieces of monitoring data being determined based on the packet, deciding whether first monitoring data included in a plurality of pieces of the monitoring data satisfy a predetermined reference, transmitting the first monitoring data to a cloud server (700) via a network when the first monitoring data do not satisfy the reference, and transmitting second monitoring data included in a plurality of pieces of the monitoring data together with the first monitoring data to the cloud server (700) via a core network (500) when the monitoring data satisfy the reference.

### TECHNICAL FIELD

The present disclosure relates to a data collection method, a sensor device, a server device, a visualization system, and a program.

### BACKGROUND ART

In recent years, maintaining or improving quality of a wireless communication system by a cloud server managing communication quality in the wireless communication system has been performed. The cloud server acquires information on the communication quality from a wireless communication terminal in the wireless communication system. Further, the cloud server causes a display unit such as a display to display the acquired information, thereby an administrator can easily recognize the communication quality of the wireless communication system.

Patent Literature 1 discloses a communication system in which a monitoring device collects monitoring information of load equipment via a gateway device. The gateway device of Patent Literature 1 periodically transmits the monitoring information to the monitoring device when the monitoring information indicates normal, and immediately transmits the monitoring information to the monitoring device when the monitoring information indicates abnormal.

### CITATION LIST

### Patent Literature

[Patent Literature 1] Japanese Unexamined Patent Application Publication

### SUMMARY OF INVENTION

### Technical Problem

In the communication system disclosed in Patent Literature 1, when monitoring information indicates normal, the gateway device increases an interval for transmitting the monitoring information to the monitoring device compared with a case where the monitoring information indicates abnormal. However, the gateway device transmits all of pieces of the collected monitoring information to the monitoring device regardless of whether the monitoring information indicates normal or abnormal. Therefore, an amount of data of the monitoring information being transmitted from the gateway device to the monitoring device does not change regardless of whether the monitoring information indicates normal or abnormal. Therefore, when the number of pieces of load equipment being monitored by the monitoring device increases, an amount of data being transmitted from the gateway device to the monitoring device also increases, and a problem that a load of the monitoring device increases occurs.

An object of the present disclosure is to provide a data collection method, a sensor device, a server device, a visualization system, and a program that are capable of suppressing an amount of data being transmitted to a server device that performs monitoring.

### Solution to Problem

A data collection method according to a first aspect of the present disclosure includes: collecting a packet being transmitted in a wireless system; generating a plurality of pieces of monitoring data being determined based on the packet; deciding whether first monitoring data included in a plurality of pieces of the monitoring data satisfy a predetermined reference; transmitting the first monitoring data to a server device via a network when the first monitoring data do not satisfy the reference; and transmitting second monitoring data included in a plurality of pieces of the monitoring data together with the first monitoring data to the server device via the network when the monitoring data satisfy the reference.

A sensor device according to a second aspect of the present disclosure includes: a packet collection unit that collects a packet being transmitted in a wireless system; a generation unit that generates a plurality of pieces of monitoring data being determined based on the packet; a decision unit that decides whether first monitoring data included in a plurality of pieces of the monitoring data satisfy a predetermined reference; and a communication unit that transmits the first monitoring data to a server device via a network when the first monitoring data do not satisfy the reference, and transmits second monitoring data included in a plurality of pieces of the monitoring data together with the first monitoring data to the server device via the network when the monitoring data satisfy the reference.

A server device according to a third aspect of the present disclosure includes a communication unit that transmits, via a network, a reference to be satisfied by first monitoring data included in a plurality of pieces of monitoring data determined based on a packet to a sensor device that collects the packet being transmitted in a wireless system, and receives, via the network, the first monitoring data that do not satisfy the reference, or the first monitoring data that satisfy the reference and second monitoring data included in a plurality of pieces of the monitoring data.

A visualization system according to a fourth aspect of the present disclosure includes: a sensor device including a packet collection unit that collects a packet being transmitted in a wireless system, a generation unit that generates a plurality of pieces of monitoring data being determined based on the packet, a decision unit that decides whether first monitoring data included in a plurality of pieces of the monitoring data satisfy a predetermined reference, and a communication unit that transmits the first monitoring data to a server device via a network when the first monitoring data do not satisfy the reference, and transmits second monitoring data included in a plurality of pieces of the monitoring data together with the first monitoring data to the server device via the network when the monitoring data satisfy the reference; and a server device including a communication unit that transmits the reference to the sensor device via the network.

A program according to a fifth aspect of the present disclosure causes a computer to execute: collecting a packet being transmitted in a wireless system; generating a plurality of pieces of monitoring data being determined based on the packet; deciding whether first monitoring data included in a plurality of pieces of the monitoring data satisfy a predetermined reference; transmitting the first monitoring data to a server device via a network when the first monitoring data do not satisfy the reference; and transmitting second monitoring data included in a plurality of pieces of the monitoring data together with the first monitoring data to the server device via the network when the monitoring data satisfy the reference.

### Advantageous Effects of Invention

According to the present disclosure, a data collection method, a sensor device, a server device, a visualization system, and a program that are capable of suppressing an amount of data being transmitted to a server device that performs monitoring can be provided.

### BRIEF DESCRIPTION OF DRAWINGS

FIG. 1 is a configuration diagram of a sensor device according to a first example embodiment;

FIG. 2 is a configuration diagram of a visualization system according to a second example embodiment;

FIG. 3 is a configuration diagram of a wireless sensor according to the second example embodiment;

FIG. 4 is a configuration diagram of a cloud server according to the second example embodiment;

FIG. 5 is a diagram illustrating a flow of transmission processing of monitoring data in the wireless sensor according to the second example embodiment;

FIG. 6 is a diagram illustrating a flow of change processing of setting information in the cloud server according to the second example embodiment; and

FIG. 7 is a configuration diagram of a sensor device, a wireless sensor, and a cloud server according to each of example embodiments.

### EXAMPLE EMBODIMENT

### Example Embodiment 1

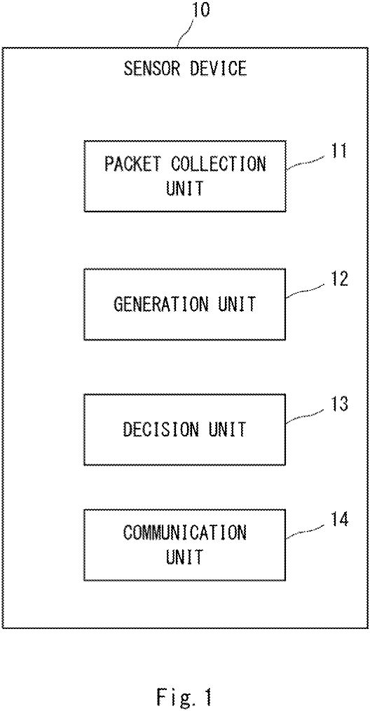

An example embodiment of the present disclosure will be described below with reference to the drawings. A configuration example of a sensor device 10 according to a first example embodiment will be described by using FIG. 1. The sensor device 10 may be a computer device that operates by a processor executing a program stored in a memory.

The sensor device 10 includes a packet collection unit 11, a generation unit 12, a decision unit 13, and a communication unit 14. A component of the sensor device 10 such as the packet collection unit 11, the generation unit 12, the decision unit 13, and the communication unit 14 may be software or a module in which processing is executed by a processor executing a program stored in a memory. Alternatively, the component of the sensor device 10 may be hardware such as a circuit or a chip.

The packet collection unit 11 collects a packet being transmitted in a wireless system. Collecting a packet may be referred to as capturing a packet.

A packet may be referred to as a transmission frame, data, or the like. The wireless system may be, for example, a communication system including a wireless section in which a packet is transmitted between a base station and a wireless terminal. The base station may be, for example, a device supporting a communication standard such as a long term evolution (LTE), or may be a device supporting another communication standard defined in a 3rd generation partnership project (3GPP). Alternatively, the wireless system may be a communication system including a wireless section in which a packet is transmitted between an access point (AP) used for a wireless local area network (LAN) and a wireless terminal. In addition, the wireless system may be a system in which a low power wide area (LPWA), a Bluetooth (registered trademark), a ZigBee (registered trademark), a 5G, a local 5G, and the like are used.

A packet transmitted in the wireless system may be, for example, a packet transmitted between a wireless terminal, and a base station or an AP. The packet may be user data such as image data or moving image data, or may be control data. The user data may be referred to as, for example, a data frame, and the control data may be referred to as a management frame or a control frame.

The generation unit 12 generates a plurality of pieces of monitoring data determined based on a packet. The monitoring data may be, for example, data indicating wireless quality. The data indicating the wireless quality may be, for example, data indicating signal strength, the number of transmission packets, the number of retransmission packets, throughput, a transmission rate, a MCS, a busy time, or the like. The data indicating the signal strength may be referred to as a received signal strength indicator (RSSI). Each of pieces of the data indicating the wireless quality may be generated for each wireless terminal communicating with a base station, an AP, or the like, or may be a total value or an average value of a plurality of wireless terminals.

The decision unit 13 decides whether first monitoring data included in the plurality of pieces of monitoring data satisfy a predetermined reference. The reference to be satisfied by the first monitoring data may be input in advance by an administrator or the like of the sensor device 10, or may be acquired in advance from a server device with which the sensor device 10 communicates. The information on the reference to be satisfied by the first monitoring data may be stored in a memory or the like in the sensor device 10.

When the decision unit 13 decides that the first monitoring data do not satisfy the predetermined reference, the communication unit 14 transmits the first monitoring data to the server device via a network. In addition, when the decision unit 13 decides that the first monitoring data satisfy the predetermined reference, the communication unit 14 transmits second monitoring data included in the plurality of pieces of monitoring data together with the first monitoring data to the server device via the network. In addition, the generation unit 12 may first generate only the first monitoring data used in the decision unit 13 to decide whether the predetermined reference is satisfied. When the decision unit 13 decides that the first monitoring data satisfy the predetermined reference, the generation unit 12 may further generate the second monitoring data.

The second monitoring data may include two or more pieces of monitoring data, or may be monitoring data generated by combining two or more pieces of monitoring data.

As described above, the sensor device 10 can determine whether to transmit another piece of monitoring data included in the plurality of pieces of monitoring data to the server device via the network, based on the first monitoring data determined based on the collected packet. As a result, the sensor device 10 can suppress an amount of the monitoring data to be transmitted to the server device, as compared with a case where all of pieces of the monitoring data generated in the sensor device are transmitted to the server device. Thus, occurrence of congestion in the network can be suppressed, and further, a processing load in the server device can be reduced.

### Example Embodiment 2

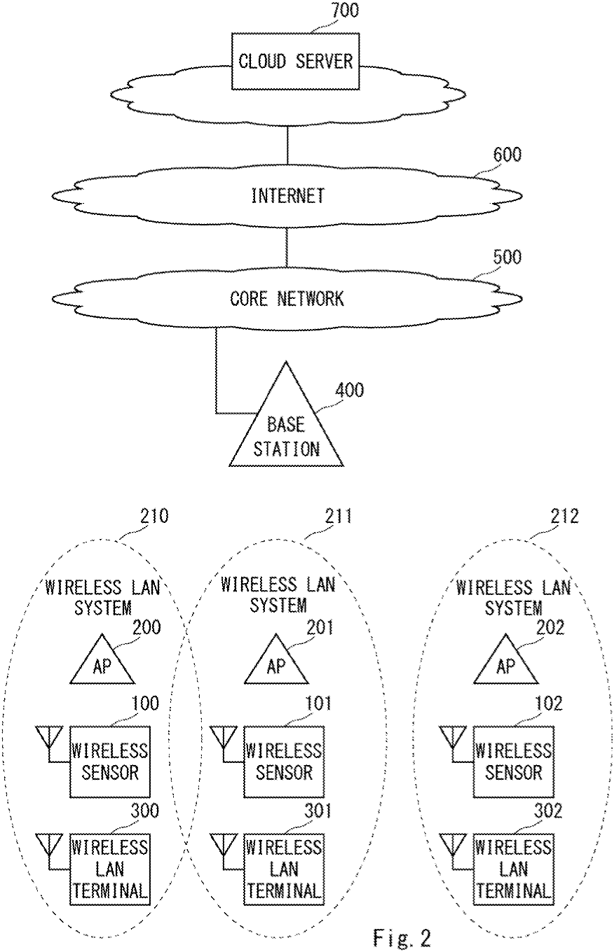

Subsequently, a configuration example of a visualization system according to a second example embodiment will be described by using FIG. 2. The visualization system is a system in which a cloud server 700 visualizes a quality situation and the like of a wireless communication area by using information acquired from a plurality of wireless sensors.

The visualization system in FIG. 2 includes wireless LAN systems 210 to 212, a base station 400, a core network 500, the Internet 600, and a cloud server 700. In addition, an AP 200 is installed in a wireless LAN communication area of the wireless LAN system 210. Further, an AP 201 is installed in a wireless LAN communication area in the wireless LAN system 211. Furthermore, an AP 202 is installed in a wireless LAN communication area in the wireless LAN system 212.

A wireless LAN terminal 300 performs wireless LAN communication with the AP 200. The wireless LAN terminal 300 may be referred to as, for example, a wireless LAN slave unit, and the AP 200 may be referred to as a wireless LAN master unit. Further, a wireless sensor 100 captures a packet transmitted and received between the wireless LAN terminal 300 and the AP 200.

A wireless LAN terminal 301 performs wireless LAN communication with the AP 201. The wireless LAN terminal 301 may be referred to as, for example, a wireless LAN slave unit, and the AP 201 may be referred to as a wireless LAN master unit. Further, a wireless sensor 101 captures a packet transmitted and received between the wireless LAN terminal 301 and the AP 201.

A wireless LAN terminal 302 performs wireless LAN communication with the AP 202. The wireless LAN terminal 302 may be referred to as, for example, a wireless LAN slave unit, and the AP 202 may be referred to as a wireless LAN master unit. Further, a wireless sensor 102 captures a packet transmitted and received between the wireless LAN terminal 302 and the AP 202.

Each of the wireless sensors 100 to 102 is equivalent to a sensor device 10 in FIG. 1. The wireless sensors 100 to 102 perform two-way communication with the cloud server 700 via the base station 400, the core network 500, and the Internet 600. The base station 400 may support an LTE, a 5G, or a local 5G, for example, as a wireless communication standard. The base station 400 establishes an LTE line, a 5G line, or a local 5G line between the base station 400, and the wireless sensors 100 to 102 or a wireless terminal, and performs data communication. In addition, the wireless sensors 100 to 102 may communicate with the Internet 600 via a wired line or an Ethernet (registered trademark). In addition, the cloud server 700 may be disposed in an intranet constructed within a specific company or the like.

In FIG. 2, a configuration in which there are three wireless LAN systems in the visualization system is illustrated, but the number of wireless LAN systems in the visualization system is not limited to three. In addition, in FIG. 2, a configuration in which one wireless sensor is installed in the wireless LAN system is illustrated, but the number of wireless sensors installed in the wireless LAN system is not limited to one. In addition, in FIG. 2, a configuration in which one wireless LAN terminal is connected to one AP is illustrated, but the number of wireless LAN terminals connected to one AP is not limited to one.

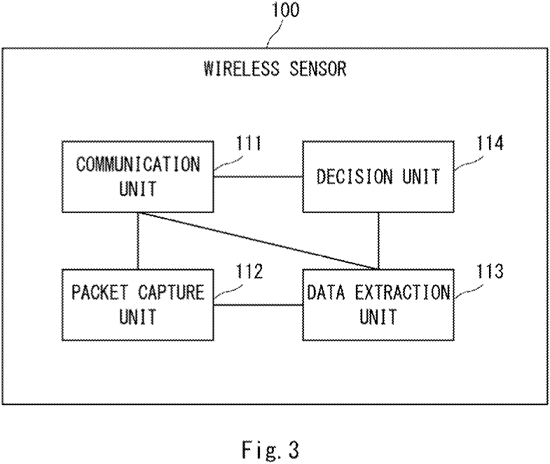

Subsequently, a configuration example of the wireless sensor 100 according to the second example embodiment will be described by using FIG. 3. In addition, since the wireless sensor 101 and the wireless sensor 102 have a similar configuration with the wireless sensor 100, detailed description thereof is omitted.

The wireless sensor 100 includes a communication unit 111, a packet capture unit 112, a data extraction unit 113, and a decision unit 114. The communication unit 111, the packet capture unit 112, the data extraction unit 113, and the decision unit 114 may be software or a module in which processing is executed by a processor executing a program stored in a memory. Alternatively, the communication unit 111, the packet capture unit 112, the data extraction unit 113, and the decision unit 114 may be hardware such as a circuit or a chip.

The communication unit 111 is equivalent to a communication unit 14 of a sensor device 10, the packet capture unit 112 is equivalent to a packet collection unit 11, the data extraction unit 113 is equivalent to a generation unit 12, and the decision unit 114 is equivalent to a decision unit 13.

The communication unit 111 performs communication with the base station 400. The communication unit 111 performs communication with the base station 400 by using, for example, a wireless communication standard defined in 3GPP. Specifically, the communication unit 111 may communicate with the base station 400 by using an LTE. The communication unit 111 may be configured by an antenna, a modulator, and a demodulator that are associated to a frequency of wireless communication with the base station 400.

The communication unit 111 acquires a collection condition, an extraction condition, and reference information of a packet from the cloud server 700 via the base station 400, the core network 500, and the Internet 600. The collection condition of a packet may be referred to as a capture condition of the packet. The communication unit 111 outputs the collection condition to the packet capture unit 112, outputs the extraction condition to the data extraction unit 113, and outputs the reference information to the decision unit 114. The communication unit 111 may periodically receive the collection condition, the extraction condition, and the reference information from the cloud server 700, or may irregularly receive the collection condition, the extraction condition, or the reference information having been changed. The collection condition, the extraction condition, and the reference information are set in the cloud server 700.

The packet capture unit 112 captures, according to the collection condition, a packet transmitted and received between the AP 200 and the wireless LAN terminal 300, and further between the AP 200 and another wireless LAN terminal. The collection condition may be, for example, a frequency band, a frequency channel, a collection time, a collection period, a number of bytes, and the like. The collection condition may be one of a frequency band, a frequency channel, a collection time, a collection period, a number of bytes, and the like, and two or more thereof may be combined.

The packet capture unit 112 may be configured by an antenna, a modulator, and a demodulator that are associated to a frequency of wireless LAN communication with the AP 200.

When two frequency channels are set as the collection condition, the packet capture unit 112 may capture packets of different frequency channels simultaneously by using two antennas, two modulators, and two demodulators. Alternatively, when two frequency channels are set as the collection condition, the packet capture unit 112 may capture packets of different frequency channels by switching the frequency channel at each predetermined time by using one antenna, one modulator, and one demodulator.

The data extraction unit 113 extracts, according to the extraction condition, a packet from among the packets captured by the packet capture unit 112. Extracting a packet may be referred to as selecting a packet. The extraction condition may be, for example, a transmission destination basic service set identifier (BSSID) or a transmission source BSSID of a packet. For example, a media access control (MAC) address of the AP 200 may be set in the BSSID. In addition, the extraction condition may be a transmission destination IP address or a transmission source IP address of a packet. In addition, the extraction condition may be a transmission destination MAC address or a transmission source MAC address of a packet. In other words, the data extraction unit 113 may extract a packet transmitted from a specific wireless LAN terminal, for example, the wireless LAN terminal 300, from among the captured packets. Alternatively, the data extraction unit 113 may extract all packets transmitted to the AP 200 in the wireless LAN system 210. The data extraction unit 113 may specify addresses of a plurality of wireless LAN terminals as the extraction condition. In addition, an IP address or a MAC address relating to a packet to be captured may be specified as the extraction condition, or an IP address or a MAC address relating to a packet not to be captured may be specified.

Further, the data extraction unit 113 generates monitoring data to be observed or measured from the extracted packet. For example, the data extraction unit 113 may generate RSSI data to be observed from the extracted packet. The RSSI is not a RSSI of the packet received by the wireless LAN terminal 300 or the AP 200, but a RSSI of the packet received by the wireless sensor 100.

Further, the data extraction unit 113 may generate throughput data and transmission rate data of a packet transmitted by the wireless LAN terminal 300 by using the number of packets transmitted from the wireless LAN terminal 300 within a predetermined period, and a data length and the like of the packet. Further, the data extraction unit 113 may determine whether a packet is a retransmission packet by analyzing a header portion of the packet, and generate data indicating the number of retransmission packets. In addition, the data extraction unit 113 may generate data on a band occupancy rate of the wireless LAN terminal 300 by using a maximum line speed between the AP 200 and the wireless LAN terminal 300 and throughput data of the wireless LAN terminal 300. In addition, the data extraction unit 113 may generate data on a retransmission rate of a packet by using the total number of received packets and the number of retransmission packets. The retransmission rate of a packet may be generated for each wireless LAN terminal, or may be generated as data of the entire wireless LAN system 210.

The decision unit 114 compares monitoring data related to the reference information received from the communication unit 111 among the plurality of pieces of monitoring data generated in the data extraction unit 113, with the reference information. For example, when the reference information indicates an RSSI value such as -60 dBm, the decision unit 114 compares the RSSI data with the reference information. A value of RSSI indicated as the reference information may be referred to as a threshold value. The decision unit 114 decides whether the RSSI data being the monitoring data satisfy the reference information. The RSSI data satisfying the reference information may be that a value indicated by the RSSI data exceeds a value indicated by the reference information. In other words, the RSSI data satisfying the reference information may be that reception quality of the wireless sensor 100 is better than a predetermined reference.

When the decision unit 114 decides that the RSSI data being the monitoring data do not satisfy the reference information, the decision unit 114 outputs the RSSI data together with a decision result to the communication unit 111. In addition, when the decision unit 114 decides that the RSSI data being the monitoring data satisfy the reference information, the decision unit 114 outputs a decision result, the RSSI data, and the monitoring data other than the RSSI data to the communication unit 111.

In addition, when the reference information indicates the number of packets in a predetermined period, the decision unit 114 compares the number of captured packets with the reference information. When the number of captured packets exceeds the reference information, it may be decided that the number of captured packets satisfies the reference information. The number of packets in the predetermined period indicated by the reference information may indicate the number of packets normalized in a predetermined period, for example, 10 packets per 10 seconds and 20 packets per 20 seconds.

The communication unit 111 transmits the monitoring data received from the decision unit 114 to the cloud server 700 via the base station 400, the core network 500, and the Internet 600.

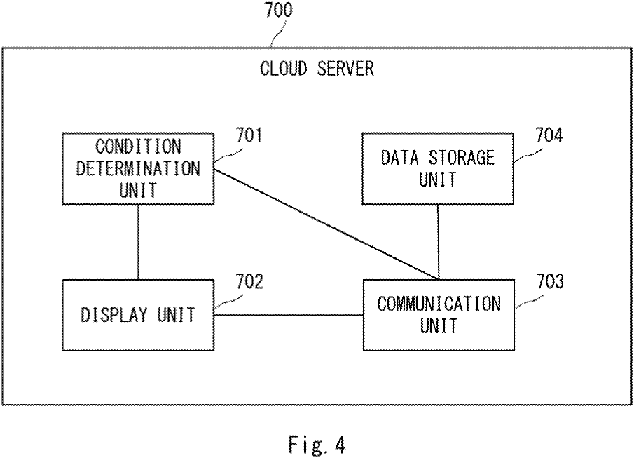

Subsequently, a configuration example of the cloud server 700 will be described by using FIG. 4. The cloud server 700 may be a computer device that operates by a processor executing a program stored in a memory. In addition, the cloud server 700 may have a built-in memory for storing a database, or may be connected to a database server device via a network, a cable, or the like. The cloud server 700 stores data received from the wireless sensors 100 to 102 in the database.

The cloud server 700 includes a condition determination unit 701, a display unit 702, a communication unit 703, and a data storage unit 704. The condition determination unit 701, the display unit 702, the communication unit 703, and the data storage unit 704 may be software or a module in which processing is executed by a processor executing a program stored in a memory. Alternatively, the condition determination unit 701, the display unit 702, the communication unit 703, and the data storage unit 704 may be hardware such as a circuit or a chip.

The condition determination unit 701 causes the display unit 702 to display information relating to setting of the collection condition, the extraction condition, and the reference information. An administrator of the cloud server 700 may confirm the information displayed on the display unit 702, and input the collection condition, the extraction condition, and the reference information. The display unit 702 may display, for example, parameter information, threshold value information, and the like selectable as the collection condition, the extraction condition, and the reference information.

The condition determination unit 701 stores, in the data storage unit 704 via the communication unit 703, the collection condition, the extraction condition, and the reference information that are determined according to the input information. In addition, the communication unit 703 transmits the collection condition, the extraction condition, and the reference information that are output from the condition determination unit 701 to at least one of the wireless sensors 100 to 102 via the Internet 600, the core network 500, and the base station 400. The condition determination unit 701 may determine different collection conditions, extraction conditions, or pieces of reference information for each AP. The collection conditions and the like determined for each AP are commonly applied to a plurality of wireless sensors that perform wireless LAN communication with the AP 200, for example. Alternatively, the condition determination unit 701 may determine different collection conditions, extraction conditions, or pieces of reference information for each wireless sensor.

When the collection condition, the extraction condition, or the reference information that are different for each AP is determined, the condition determination unit 701 transmits the collection condition, the extraction condition, or the reference information to each of APs, and transmits the collection condition, the extraction condition, or the reference information to a subordinate wireless sensor via the AP. In addition, when different collection conditions, extraction conditions, or pieces of reference information are determined for each wireless sensor, the condition determination unit 701 transmits the collection condition and the like by using a destination of the collection condition and the like as the wireless sensor.

When the collection condition, the extraction condition, or the reference information is changed, the condition determination unit 701 may transmit a change notification indicating that the collection condition, the extraction condition, or the reference information is changed, to each of wireless sensors. In this case, the wireless sensor that has received the change notification accesses the cloud server 700, and acquires the collection condition, the extraction condition, or the reference information after change. Alternatively, the condition determination unit 701 may transmit the changed information to the wireless sensor without transmitting the change notification. Alternatively, the condition determination unit 701 may periodically transmit the collection condition, the extraction condition, or the reference information to each of wireless sensors. In addition, the condition determination unit 701 outputs the collection condition, the extraction condition, or the reference information after change to the data storage unit 704 via the communication unit 703. The data storage unit 704 stores the received collection condition, extraction condition, or reference information after change.

In addition, the communication unit 703 receives monitoring data from the wireless sensors 100 to 102. The communication unit 703 stores the received monitoring data in the data storage unit 704. The display unit 702 processes the data stored in the data storage unit 704 into display data, and displays the display data.

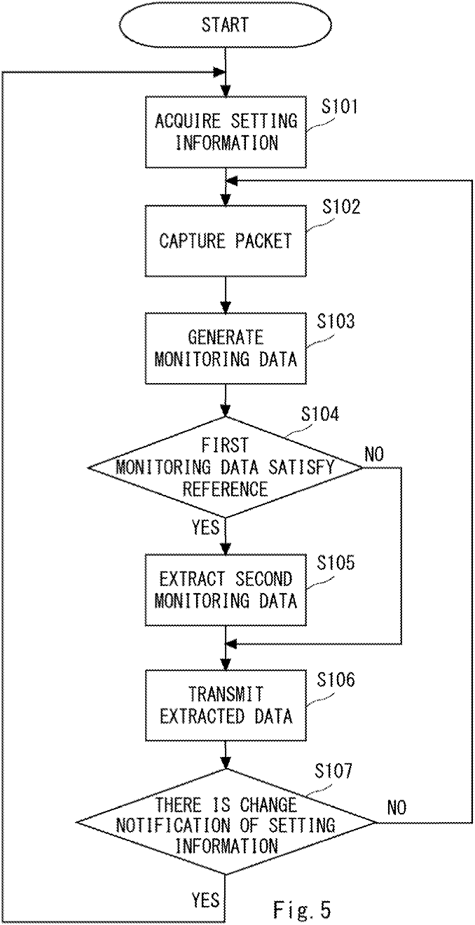

Subsequently, a flow of transmission processing of monitoring data in the wireless sensor 100 according to the second example embodiment will be described by using FIG. 5. First, the communication unit 111 receives setting information from the cloud server 700 (S101). The setting information includes at least one of a collection condition, an extraction condition, and reference information. For example, the communication unit 111 may receive a newly set collection condition, extraction condition, and reference information, or may receive changed collection condition, extraction condition, or reference information.

Next, the packet capture unit 112 captures a packet transmitted and received in the wireless LAN system 210 according to the collection condition (S102). Next, the data extraction unit 113 generates monitoring data to be observed from the extracted packet according to the extraction condition (S103).

Next, the decision unit 114 extracts first monitoring data from a plurality of pieces of the monitoring data, and decides whether the first monitoring data satisfy the reference information (S104). The decision unit 114 extracts RSSI data as the first monitoring data, for example. The decision unit 114 decides whether the RSSI data being the monitoring data exceed a threshold value indicated by the reference information. When the RSSI data exceed the threshold value, it is decided that the first monitoring data satisfy the reference information.

When the decision unit 114 decides that the first monitoring data satisfy the reference information, the decision unit 114 extracts second monitoring data different from the first monitoring data from the plurality of pieces of monitoring data (S105). For example, the decision unit 114 may extract throughput data, data related to a retransmission rate, and the like.

Next, the communication unit 111 transmits the data extracted by the decision unit 114 to the cloud server 700 (S106). The data extracted by the decision unit 114 include the first monitoring data and the second monitoring data.

Next, the communication unit 111 decides whether a change notification of the setting information has been received from the cloud server 700 (S107). When the communication unit 111 receives the change notification of the setting information, the processing in and after step S101 is repeated. When the communication unit 111 has not received the change notification of the setting information, the processing in and after step S102 is repeated.

In addition, in step S104, when the decision unit 114 decides that the first monitoring data do not satisfy the reference information, the processing of step S106 is executed without executing step S105. In other words, when the decision unit 114 decides that the first monitoring data do not satisfy the reference information, the communication unit 111 transmits only the first monitoring data to the cloud server 700. In other words, when the decision unit 114 determines that the first monitoring data do not satisfy the reference information, the decision unit 114 transmits the already extracted monitoring data to the cloud server 700 without extracting new monitoring data.

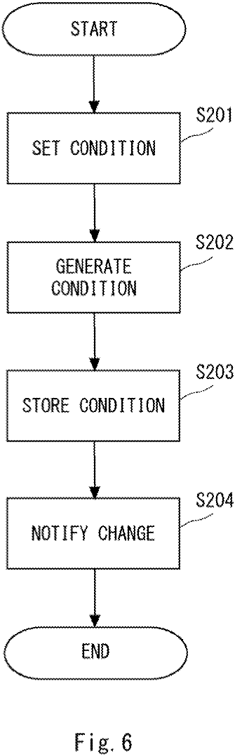

Subsequently, by using FIG. 6, a flow of change processing of the setting information in the cloud server 700 according to the second example embodiment will be described. First, the condition determination unit 701 displays, on the display unit 702, information relating to setting of the collection condition, the extraction condition, and the reference information, and accepts the setting of the collection condition, the extraction condition, and the reference information from an administrator (S201). Next, the condition determination unit 701 generates the collection condition, the extraction condition, and reference information according to information input from an administrator (S202).

Next, the condition determination unit 701 stores the generated collection condition, extraction condition, and reference information in the data storage unit 704 (S203). For example, the condition determination unit 701 outputs the collection condition, the extraction condition, and the reference information to the data storage unit 704 via the communication unit 703. In addition, the communication unit 703 transmits the collection condition, the extraction condition, and the reference information to the wireless sensors 100 to 102 via the Internet 600, the core network 500, the base station 400, and the APs 200 to 202.

Next, when the collection condition, the extraction condition, or the reference information is changed by being input new information from an administrator or the like, the condition determination unit 701 transmits the collection condition, the extraction condition, or the reference information after change, to the wireless sensors 100 to 102 via the communication unit 703.

As described above, by using the visualization system according to the second example embodiment, data to be transmitted from the wireless sensors 100 to 102 to the cloud server 700 can be selected. As a result, since an amount of data transmitted through the core network 500 and the Internet 600 can be reduced, it is possible to avoid occurrence of congestion in the core network 500 and the Internet 600. Further, an increase in a processing load on the cloud server 700 can be avoided.

In addition, it indicates that wireless quality is better as a value of RSSI increases. Therefore, monitoring data generated based on a packet captured by the wireless sensor having the high RSSI have higher reliability than monitoring data generated based on a packet captured by the wireless sensor having the low RSSI. Therefore, the cloud server 700 can collect monitoring data having high reliability by acquiring a plurality of pieces of monitoring data from the wireless sensor whose RSSI data satisfy the reference information as the monitoring data.

A similar result can be acquired by using the number of packets instead of the RSSI. The higher the RSSI, the higher an acquisition rate of packets in the wireless sensor. In other words, it indicates that the wireless quality is better as the number of packets captured by the wireless sensor increases.

In addition, when a plurality of wireless sensors are installed in one wireless LAN system, for example, the wireless LAN system 210, the cloud server 700 may decide that a wireless sensor that has transmitted the highest RSSI data is an optimal wireless sensor. The wireless sensor that has transmitted the highest RSSI data can be said to be a wireless sensor that has captured a packet in an environment with good wireless quality. In this case, the cloud server 700 may adopt monitoring data received from the optimal wireless sensor as the monitoring data in the wireless LAN system 210, and display the monitoring data on the display unit 702. As a result, the cloud server 700 can display monitoring data having high reliability as data indicating wireless quality and the like in each of wireless LAN systems.

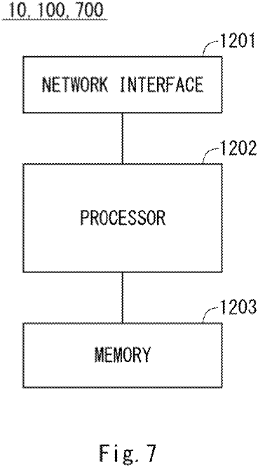

FIG. 7 is a block diagram illustrating a configuration example of the sensor device 10, the wireless sensor 100, and the cloud server 700 (hereinafter, referred to the sensor device 10 and the like). Referring to FIG. 7, the sensor device 10 and the like include a network interface 1201, a processor 1202, and a memory 1203. The network interface 1201 is used for communicating with a network node (e.g., an eNB, an MME, a P-GW,). The network interface 1201 may include, for example, a network interface card (NIC) compliant with IEEE 802.3 series. Herein, an eNB represents an evolved node B, an MME represents a mobility management entity, and a P-GW represents a packet data network gateway. IEEE represents the Institute of Electrical and Electronics Engineers.

The processor 1202 reads software (a computer program) from the memory 1203 and executes the software (computer program), and thereby performs processing of the sensor device 10 and the like described by using the flowcharts in the above-described example embodiments. The processor 1202 may be, for example, a microprocessor, a MPU, or a CPU. The processor 1202 may include a plurality of processors.

The memory 1203 is configured by a combination of a volatile memory and a nonvolatile memory. The memory 1203 may include a storage disposed away from the processor 1202. In this case, the processor 1202 may access the memory 1203 via an input/output (I/O) interface being not illustrated.

In the example in FIG. 7, the memory 1203 is used for storing a software module group. The processor 1202 reads the software module group from the memory 1203 and executes the module group, and thereby can perform the processing of the sensor device 10 and the like described in the above example embodiments.

As described by using FIG. 7, each of the processors included in the sensor device 10 and the like in the above-described example embodiments executes one or a plurality of programs including an instruction group for causing a computer to execute an algorithm described by using the drawings.

In the above examples, a program can be stored by using various types of non-transitory computer readable media, and supplied to a computer. The non-transitory computer readable medium includes various types of tangible storage media. Examples of the non-transitory computer readable medium include a magnetic recording medium (e.g., a flexible disk, a magnetic tape, a hard disk drive), a magneto-optical recording medium (e.g., a magneto-optical disk), a CD-read only memory (ROM), a CD-R, a CD-R/W, and a semiconductor memory (e.g., a mask ROM, a programmable ROM (PROM), an erasable PROM (EPROM), a flash ROM, a random access memory (RAM)). In addition, the program may also be supplied to the computer by various types of transitory computer readable media. Examples of the transitory computer readable medium include an electric signal, an optical signal, and an electromagnetic wave. The transitory computer readable medium can supply the program to the computer via a wired communication path such as an electric wire and an optical fiber, or a wireless communication path.

Note that, the present disclosure is not limited to the above-mentioned example embodiments, and can be modified as appropriate within a range not deviating from the gist.

Although the invention of the present application has been described above with reference to the example embodiments, the invention of the present application is not limited to the above. Various modifications can be made to the structure and details of the invention of the present application which can be understood by a person skilled in the art within the scope of the invention.

Some or all of the above example embodiments may also be described as the following supplementary notes, but are not limited to the following.

### (Supplementary Note 1)

A data collection method comprising:
collecting a packet being transmitted in a wireless system; generating a plurality of pieces of monitoring data being determined based on the packet;
deciding whether first monitoring data included in a plurality of pieces of the monitoring data satisfy a predetermined reference;
transmitting the first monitoring data to a server device via a network when the first monitoring data do not satisfy the reference; and
transmitting second monitoring data included in a plurality of pieces of the monitoring data together with the first monitoring data to the server device via the network when the monitoring data satisfy the reference.

### (Supplementary Note 2)

The data collection method according to Supplementary note 1, wherein the first monitoring data are data related to wireless quality.

### (Supplementary Note 3)

The data collection method according to Supplementary note 1 or 2, wherein the first monitoring data indicate reception signal strength when a packet being transmitted from a wireless terminal in the wireless system is received.

### (Supplementary Note 4)

The data collection method according to any one of Supplementary notes 1 to 3, wherein the second monitoring data are generated by combining two or more pieces of the monitoring data included in a plurality of pieces of the monitoring data.

### (Supplementary Note 5)

The data collection method according to any one of Supplementary notes 1 to 4, wherein, when collecting the packet, the server device collects the packet according to a predetermined collection condition.

### (Supplementary Note 6)

The data collection method according to Claim 5, wherein the reference and the collection condition are received from the server device prior to collecting the packet.

### (Supplementary Note 7)

A sensor device comprising:
packet collection means for collecting a packet being transmitted in a wireless system;
generation means for generating a plurality of pieces of monitoring data being determined based on the packet;
decision means for deciding whether first monitoring data included in a plurality of pieces of the monitoring data satisfy a predetermined reference; and communication means for transmitting the first monitoring data to a server device via a network when the first monitoring data do not satisfy the reference, and
transmitting second monitoring data included in a plurality of pieces of the monitoring data together with the first monitoring data to the server device via the network when the monitoring data satisfy the reference.

### (Supplementary Note 8)

The sensor device according to Supplementary note 7, wherein the first monitoring data are data related to wireless quality.

### (Supplementary Note 9)

A server device comprising communication means for transmitting, via a network, a reference to be satisfied by first monitoring data included in a plurality of pieces of monitoring data determined based on a packet to a sensor device that collects the packet being transmitted in a wireless system, and receiving, via the network, the first monitoring data that do not satisfy the reference, or the first monitoring data that satisfy the reference and second monitoring data included in a plurality of pieces of the monitoring data.

### (Supplementary Note 10)

The server device according to Supplementary note 9, wherein the communication means transmits a collection condition indicating a condition of a packet to be collected by the sensor device, to the sensor device.

### (Supplementary Note 11)

A visualization system comprising:
a sensor device configured to include packet collection means for collecting a packet being transmitted in a wireless system, generation means for generating a plurality of pieces of monitoring data being determined based on the packet, decision means for deciding whether first monitoring data included in a plurality of pieces of the monitoring data satisfy a predetermined reference, and
communication means for transmitting the first monitoring data to a server device via a network when the first monitoring data do not satisfy the reference, and transmitting second monitoring data included in a plurality of pieces of the monitoring data together with the first monitoring data to the server device via the network when the monitoring data satisfy the reference; and
a server device configured to include communication means for transmitting the reference to the sensor device via the network.

### (Supplementary Note 12)

The visualization system according to Supplementary note 11, wherein the first monitoring data are data relating to wireless quality.

### (Supplementary Note 13)

A non-transitory computer-readable medium storing a program causing a computer to execute:
collecting a packet being transmitted in a wireless system;
generating a plurality of pieces of monitoring data being determined based on the packet;
deciding whether first monitoring data included in a plurality of pieces of the monitoring data satisfy a predetermined reference; transmitting the first monitoring data to a server device via a network when the first monitoring data do not satisfy the reference; and
transmitting second monitoring data included in a plurality of pieces of the monitoring data together with the first monitoring data to the server device via the network when the monitoring data satisfy the reference.

### (Supplementary Note 14)

A non-transitory computer-readable medium storing a program causing a computer to execute:

transmitting, via a network, a reference to be satisfied by first monitoring data included in a plurality of pieces of monitoring data determined based on a packet to a sensor device that collects the packet being transmitted in a wireless system, and receiving, via the network, the first monitoring data that do not satisfy the reference, or the first monitoring data that satisfy the reference and second monitoring data included in a plurality of pieces of the monitoring data.

Although the invention of the present application has been described above with reference to the example embodiments, the invention of the present application is not limited to the above. Various modifications can be made to the structure and details of the invention of the present application which can be understood by a person skilled in the art within the scope of the invention.

This application is based upon and claims the benefit of priority from Japanese patent application No. 2020-93935, filed on May 29, 2020, the disclosure of which is incorporated herein in its entirety by reference.

Reference Signs List

| | |
|---|---|
| 10 | SENSOR DEVICE |
| 11 | PACKET COLLECTION UNIT |
| 12 | GENERATION UNIT |
| 13 | DECISION UNIT |
| 14 | COMMUNICATION UNIT |
| 100 | WIRELESS SENSOR |
| 101 | WIRELESS SENSOR |
| 102 | WIRELESS SENSOR |
| 111 | COMMUNICATION UNIT |
| 112 | PACKET CAPTURE UNIT |
| 113 | DATA EXTRACTION UNIT |
| 114 | DECISION UNIT |
| 200 | AP |
| 201 | AP |
| 202 | AP |
| 210 | WIRELESS LAN SYSTEM |
| 211 | WIRELESS LAN SYSTEM |
| 212 | WIRELESS LAN SYSTEM |
| 300 | WIRELESS LAN TERMINAL |
| 301 | WIRELESS LAN TERMINAL |
| 302 | WIRELESS LAN TERMINAL |
| 400 | BASE STATION |
| 500 | CORE NETWORK |
| 600 | INTERNET |
| 700 | CLOUD SERVER |
| 701 | CONDITION DETERMINATION UNIT |
| 702 | DISPLAY UNIT |
| 703 | COMMUNICATION UNIT |
| 704 | DATA STORAGE UNIT |

What is claimed is:

1] A data collection method comprising:
collecting a packet being transmitted in a wireless system;
generating a plurality of pieces of monitoring data being determined based on the packet;
deciding whether first monitoring data included in a plurality of pieces of the monitoring data satisfy a predetermined reference;
transmitting the first monitoring data to a server device via a network when the first monitoring data do not satisfy the reference; and
transmitting second monitoring data included in a plurality of pieces of the monitoring data together with the first monitoring data to the server device via the network when the first monitoring data satisfy the reference.

2] The data collection method according to claim 1, wherein the first monitoring data are data related to wireless quality.

3] The data collection method according to, claim 1, wherein the first monitoring data indicate reception signal strength when a packet being transmitted from a wireless terminal in the wireless system is received.

4] The data collection method according to, claim 1, wherein the second monitoring data are generated by combining two or more pieces of the monitoring data included in a plurality of pieces of the monitoring data.

5] The data collection method according to, claim 1,
wherein, when collecting the packet, the server device collects the packet according to a predetermined collection condition.

6] The data collection method according to claim 5, wherein the reference and the collection condition are received from the server device prior to collecting the packet.

7] A sensor device comprising:
at least one memory storing instructions, and
at least one processor configured to execute the instructions to;
collect a packet being transmitted in a wireless system;
generate a plurality of pieces of monitoring data being determined based on the packet;
decide whether first monitoring data included in a plurality of pieces of the monitoring data satisfy a predetermined reference; and
transmit the first monitoring data to a server device via a network when the first monitoring data do not satisfy the reference, and
transmitting second monitoring data included in a plurality of pieces of the monitoring data together with the first monitoring data to the server device via the network when the first monitoring data satisfy the reference.

8] The sensor device according to claim 7, wherein the first monitoring data are data related to wireless quality.

9] A server device comprising:
at least one memory storing instructions, and
at least one processor configured to execute the instructions to;
transmit, via a network, a reference to be satisfied by first monitoring data included in a plurality of pieces of monitoring data determined based on a packet to a sensor device that collects the packet being transmitted in a wireless system, and receiving, via the network, the first monitoring data that do not satisfy the reference, or the first monitoring data that satisfy the reference and second monitoring data included in a plurality of pieces of the monitoring data.

10] The server device according to claim 9, wherein the at least one processor is further configured to execute the instructions to transmit a collection condition indicating a condition of a packet to be collected by the sensor device, to the sensor device.

11-14] (canceled)
